(19) United States
(12) Patent Application Publication
(10) Pub. No.: US 2026/0339274 A1
(43) Pub. Date: Oct. 29, 2026

(54) Power Tool Safety System

(71) Applicant: WiSys Technology Foundation, Inc., Madison, WI (US)

(72) Inventors: Corey J. Hedlund, Menomonie, WI (US); Samuel P. Koland, Menomonie, WI (US); Audra L. Glosemeyer, Beloit, WI (US); Scarlett R. Kirkpatrick, Beloit, WI (US)

(21) Appl. No.: 19/661,146

(22) Filed: Apr. 28, 2026

Related U.S. Application Data
(60) Provisional application No. 63/796,030, filed on Apr. 28, 2025.

(51) Int. Cl. G05B 9/02; G06K 7/10; H01M 10/42; H01M 50/247

(52) U.S. Cl. CPC G05B 9/02; G06K 7/10366; H01M 10/425; H01M 50/247; H01M 2220/30

(57) ABSTRACT

A power tool lockout or safety system is provided that includes a tool operational interlock based on an operator's PPE (personal protective equipment) status. If PPE is not detected, then the tool may be disabled. The system may provide a default disabled status or locked state of the tool. If appropriate PPE is detected, the system may convert the tool's status to enabled, allowing its operation.

### CROSS REFERENCE TO RELATED APPLICATION

This application claims the benefit of US provisional application 63/796,030 filed Apr. 28, 2025, and hereby incorporated by reference in its entirety.

### STATEMENT REGARDING FEDERALLY SPONSORED RESEARCH OR DEVELOPMENT

### Field of the Invention

The invention relates generally to power tools and, in particular, to a power tool safety system.

### Background of the Invention

Power tools are getting increasingly versatile and powerful. Likewise, safety equipment or PPE (personal protective equipment) technology continues to develop and its implementation by power tool users is widely accepted. Nevertheless, there continues to be situations in which power tool users do not wear PPE when using power tools, whether purposefully or accidentally.

### SUMMARY OF THE INVENTION

The present inventors have identified a need to provide a system to decrease the likelihood of power tool usage by users that are not wearing PPE.

It is thus a feature of at least one embodiment of the invention to provide a system that detects presence of PPE that correlates to a user's wearing the PPE and controls selective delivery of power to a power tool based on such PPE status.

According to another aspect of the invention, the power tool safety system may include an interrupter system positioned between the power tool and its power supply. The interrupter system may place the tool in a locked (nonuse) state by default and only unlock the tool and permit its use when the system recognizes presence of PPE tags associated with required PPE.

According to another aspect of the invention, the interrupter system may be implemented in a tool body or as an adapter module for cordless power tools, situated between the tool body and battery. The adapter may include locking mechanisms to prevent bypassing and ensure that power delivery depends on PPE detection.

It is thus a feature of at least one embodiment of the invention to provide a versatile and reliable tool lockout system(s), including retrofit implementations for existing tools.

According to another aspect of the invention, a control system selectively locks or unlocks the tool by preventing or permitting signal transmission through communication conductors between a tool body and a tool battery.

It is thus a feature of at least one embodiment of the invention to provide tool locking and unlocking controls without requiring high-powered switching mechanisms.

According to another aspect of the invention, a user's wearing of multiple pieces of PPE may be required to unlock a tool for use. One of the pieces of PPE may define a primary piece of PPE upon which at least some control components may be arranged for detecting presence of another secondary piece of PPE.

It is thus a feature of at least one embodiment of the invention to facilitate detecting of a set of PPE with PPE-mounted components to reduce a number of communication paths between individual pieces of PPE and a tool control system.

These and other features and aspects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the scope of the invention.

### BRIEF DESCRIPTION OF THE DRAWINGS

FIG. 1 is a partially schematic representation of a power tool safety system in accordance with the present invention;

FIG. 2 is another partially schematic representation of a power tool safety system in accordance with the present invention;

FIG. 3 is another partially schematic representation of a power tool safety system in accordance with the present invention;

FIG. 4 is circuit diagram of a tool-side control system;

FIG. 5 is a circuit diagram of a PPE (personal protective equipment)-side control system;

FIG. 6 is a schematic representation of various use-states and component mounting positions; and

FIG. 7 is a schematic representation of various use-states.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE PREFERRED EMBODIMENTS

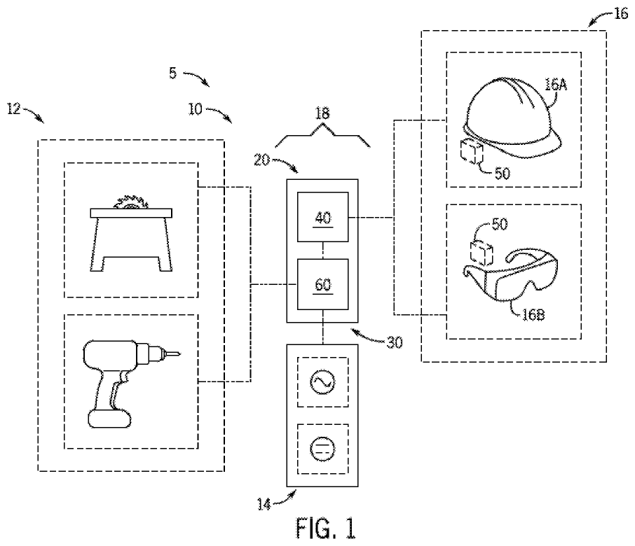

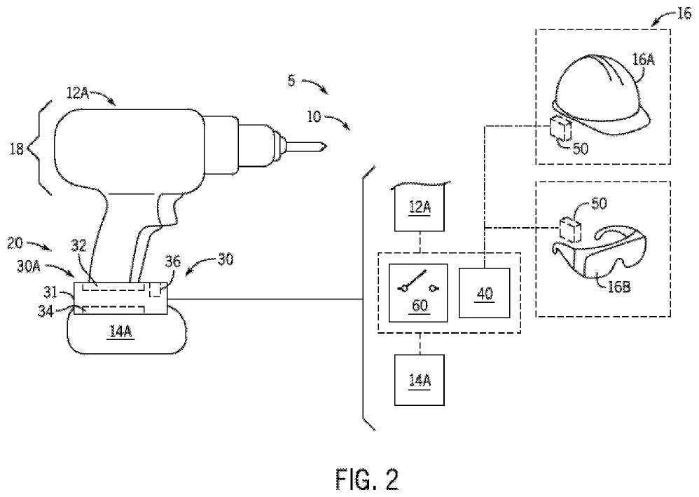

Referring now to the drawings, FIGS. 1-2 show a power tool safety system 5 with a tool lockout system, shown as system 10. System 10 is configured to selectively prevent or permit operation of a tool 12 by controlling power delivery from power supply 14 to tool 12 based on detected absence or presence of at least one piece of safety equipment or PPE (personal protection equipment) 16.

Still referring to FIG. 1, system 10 includes control system 18 that is configured for evaluating presence of PPE 16 that correlates to a user's wearing the PPE 16 and controls selective delivery of power to tool 12 based on the PPE-worn status. Control system 18 may include, for example, PPE management electronics and/or tool management electronics such as a computer(s) which may be an industrial computer or, for example, a PLC (programmable logic controller), along with corresponding software and suitable memory for storing such software and hardware including interconnecting conductors for power and signal transmission between various components of system 10. Control system 18 may control or include interrupter system 20 which is arranged at least partially between power tool 12 and power supply 14. Interrupter system 20 includes interrupter module 30 arranged between power tool 12 and the power supply 14. Interrupter module 30 may include a PPE detector 40 configured to detect the absence or presence of the piece of PPE 16. PPE identifier or PPE tag 50 is arranged at each piece of PPE 16 and is configured to be wirelessly detectable by PPE detector 40. PPE detector(s) 40 and tag(s) 50 may incorporate any of a variety of sensors, detectors and, as appropriate, corresponding identifiers or tags including those implementing, for example, RFID (Radio-Frequency Identification), NFC (Near Field Communication), magnetic-type such as hall effect sensors, reed switches, capacitive proximity sensors, IR (infrared), including reflexive or beam-break IR sensors, ultrasonic sensors, BLE (Bluetooth® low energy), or pressure sensor technologies. Others include, for example, RF energy harvesting, weight sensors/load cells, computer vision (optical recognition or other camera/imaging), LIDAR (light detection and ranging).

Still referring to FIG. 1, power disconnect arrangement 60 of interrupter module 30 is in operable communication with PPE detector 40. Power disconnect arrangement 60 is configured to selectively prevent or permit delivery of power from power supply 14 to power tool 12, directly or indirectly, based on a detected absence or presence status of PPE 16 from the PPE detector 40. This may include incorporating actuating components such as contactors, solenoids, or relays, or solid-state mechanisms such as SSRs.

Accordingly, the permit/prevent operation command(s) and control for power tool 12 may be associated with various system features associated with, for example, various electromechanical configurations such as a relay module and cooperating Bluetooth microcontroller, typically implemented as a microcontroller (ESP32) that receives Bluetooth commands and controls a relay to switch power. Such implementation is typically used for high-current loads where slower switching speeds are acceptable, such as high-powered stationary tools. Various semiconductor-based approaches may include MOSFET (metal-oxide-semiconductor field-effect transistor) including N-Channel or P-Channel along with a microcontroller that sends a control signal to switch the MOSFET to cut power and prevent tool energization. Such MOSFET implementation is typically used for internal tool configurations or portable tools as add on accessories. SSRs (solid-state relays) may be implemented with microcontrollers, similarly to relays or other electromechanical implementations, but typically used with configurations that require more frequent switching. Such SSR implementation is typically used for internal tool configurations or portable tools as add on accessories. BJTs (bipolar junction transistor) and/or IGBTs (insulated gate bipolar transistor) may be implemented with microcontrollers, similarly to MOSFETs and SSRs, again typically used with internal tool configurations or portable tools as add on accessories.

Referring now to FIG. 2, in this implementation, power tool 12 is a handheld tool, shown as drill 12A. Drill 12A is cordless and has a tool body and power supply 14 that is shown as battery 14A. Interrupter module 30 is shown as adapter 30A that interconnects drill 12A and battery 14A. Adapter 30A is shown having an interrupter module housing or adapter housing 31 with a tool interface or tool connector 32 at its upper end and a battery interface or connector 34 at its lower end. Tool and battery connectors 32, 34 have cooperating features such as conductive power and communication rails, non-conductive mounting rails or grooves, and shoulders, to securely and operably mount to tool 12A and battery 14A, respectively. Lock arrangement 36 secures adapter 30A mounted to tool 12A to prevent its removal and circumvention of system 10, for example, requiring a tool(s) to install and uninstall. Lock arrangement 36 may include a dual camlock system with a key. This may be implemented as a keyed screw with a lobed on at its end, which may be implemented at both sides of tool 12A when tool 12A has a battery lock or latching receptacle at each of the two sides. The lobed cam operates when turned and occupies the space that battery's 14A latching structure would occupy when snapped in place to mount the battery 14A to tool 12A. It is understood that tool connector's 32 lock arrangement 36 or locking system for the housing may instead be secured with electronic implementations. Examples include the housing being adapted to be secured through electronic latching arrangements with a control scheme that utilizes an RFID tag or biometrics such as fingerprints to unlock. Regardless of the particular implementation of tool connector's 32 lock arrangement 36, at the other end of adapter housing 31, battery connector 34 is configured to allow battery replacement freely on the adapter 30A in the same or analogous way to replacement directly on the tool's battery-receiving interface.

Still referring to FIG. 2, system 10 may be configured to require confirmation of more than one piece of PPE 16 to permit operation of power tool 12. Shown here, helmet or hardhat 16A and safety glasses or eye protection 16B are required to operate power tool 12. PPE detector 40 may be configured to detect the absence or presence of at least: a first piece of PPE; and a second piece of PPE the power disconnect arrangement is configured to selectively prevent or permit delivery of power from the power supply to the power tool based on a detected absence or presence status of both the first and second pieces of PPE.

Still referring to FIG. 2, whether more than one piece of PPE 16 is required for operation of power tool 12 may depend on, for example, particular jobsite rules. Jobsite rules may be defined as a function of, for example, location. In one example, a particular jobsite and its rules may require hardhat 16A in addition to eye protection 16B because of overhead lifting at the jobsite or other criteria. In such situations, interrupter module 30 may include a location detector such as a geolocation device that uses GPS to determine a user's location. Interrupter modules may require its PPE detector 40 to detect the presence of both hardhat 16A and eye protection 16B for adapter 30A to permit power transfer between power supply 14 and power tool 12.

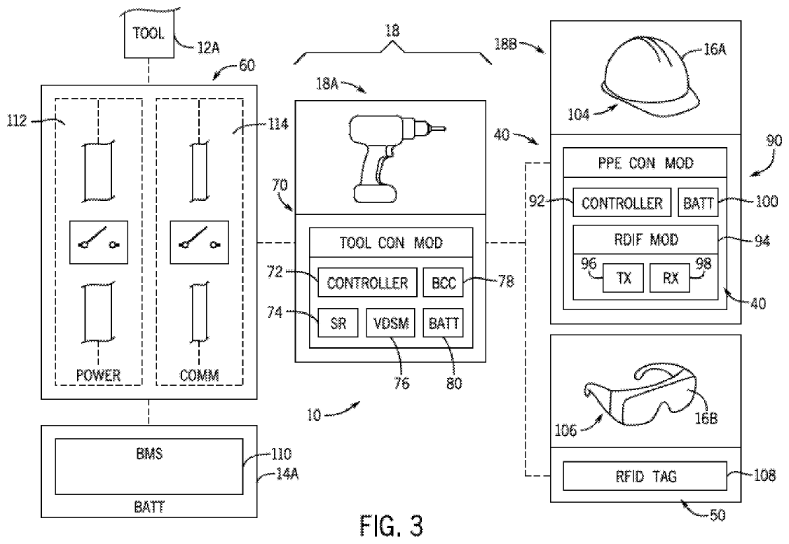

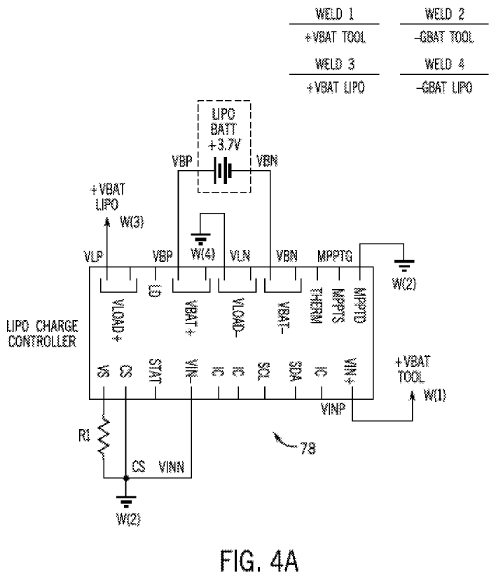

Referring now to FIG. 3, in this implementation, control system 18 is shown with tool-side control system 18A and PPE-side control system 18B. Tool-side control system 18A and PPE-side control system 18B communicate with each other, typically wirelessly such as by way of a Bluetooth connection. PPE-side control system 18B is configured to detect PPE 16 and communicate corresponding PPE status messages to tool-side control system 18A to unlock or enable use of power tool 12 when PPE requirements have been satisfied. System 10 is shown here configured for use with multiple pieces of cooperating PPE 16. PPE-side control system 18B is shown arranged in hardhat 16A and configured to detect the wearing of eye protection 16B as a function of eye protection's 16B proximity to hardhat 16A. It is understood that PPE-side control system 18B may be arranged in another piece of PPE 16, including a piece of workwear such as a high-visibility vest or jacket, that should be worn simultaneously with other pieces of PPE 16 to be detected to allow use of tool 12.

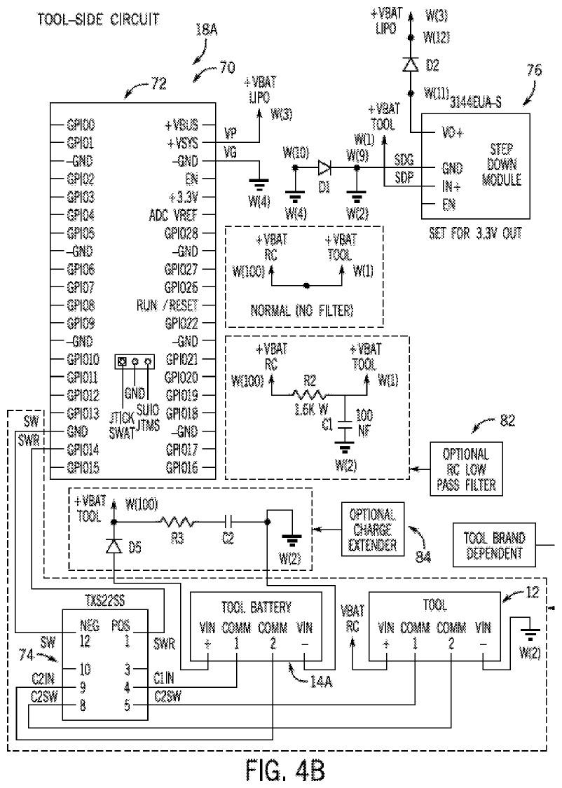

Still referring to FIG. 3 and with further reference to the circuit diagram of FIG. 4, tool-side control system 18A includes tool control module 70. Tool control module 70 includes a computer or PLC with Bluetooth, shown as tool controller 72, signal relay (SR) 74, a voltage step down module (VSDM) 76, a battery charge controller (BCC) 78, and battery (Batt) 80. Battery 80 is typically implemented as a lithium-ion battery, such as a 3.7 150mAH battery. As shown in FIG. 4, a resistor capacitor (RC) low pass filter 82 may be arranged between the tool's battery 14A and the tool battery power rail will constrain the frequency to below predetermined values, for example, 1000 Hz with a 1.6 kOhm resistor and a 100 nF capacitor which may offer component protection due to high frequencies often seen by the power rails of power tools 12. A charge extender shown as charge extension circuit 84 may be implemented that typically includes a diode between tool battery 14A and tool battery power rail, and a resistor and capacitor in series between the tool battery power rail and return, which will provide more time for a backup battery to charge even after the use of the tool 12 is complete. Controller 72 and various interacting components are typically implemented as a printed circuit board(s) (PCB) with miniature board-mounted components. It is further understood that a capacitor bank could provide additional charge time even over the single capacitor implementation that is shown here.

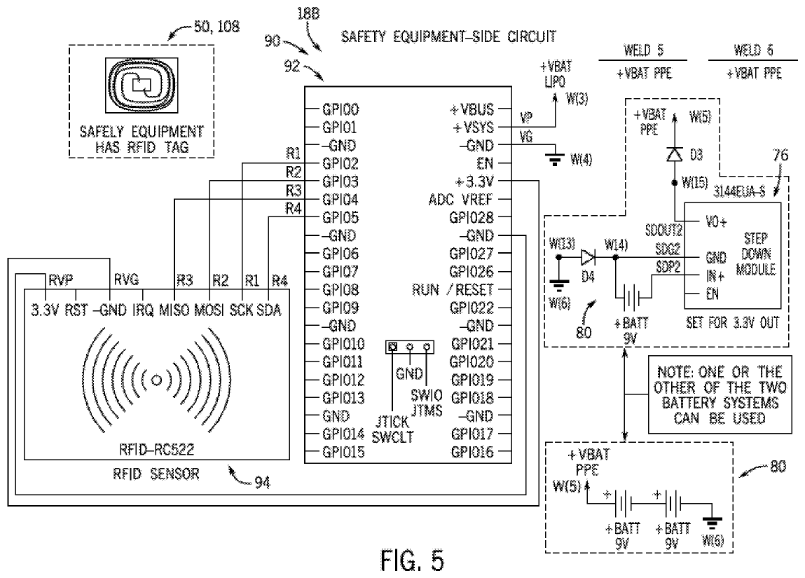

Still referring to FIG. 3 and with further reference to the circuit diagram of FIG. 5, PPE-side control system 18B includes PPE control module 90. PPE control module 90 includes a computer or PLC with Bluetooth, shown as PPE controller 92 that communicates with tool control module 70 (FIG. 4) and RFID module 94. RFID module 94 includes an RFID reader that typically includes radios or antennae configured to transmit (TX) and receive (RX) electromagnetic signals, shown as transmit antennae 96 and receive antennae 98. Although represented separately, RFID module's 94 transmit and receive antennae 96, 98 are typically implemented through a single integrated antenna as a monostatic configuration. Battery system represented as Battery 100 configured for powering PPE control module 90 and RFID module 94. Battery 100 typically has a voltage between 2V and 5V. This may be implemented as, for example, two AA batteries in series for a total of 3V, or a single 9V feeding into a voltage step down module set to ~3V, optionally other battery types or configurations for the target operating voltage. Like controller 72, PPE controller 92 and various interacting components are typically implemented as a PCB with miniature board-mounted components.

Still referring to FIG. 3, in this implementation, hardhat 16A is shown as a primary piece of PPE 16 (FIGS. 1-2) or detector PPE 104 in which PPE-side control system 18B is mounted. Eye protection 16B is shown as a secondary piece of PPE 16 (FIGS. 1-2) or detected PPE 106 that is detected by detector PPE 104 to permit operation of tool 12. PPE tag 50 is shown as RFID tag 108, which is configured to use the same communications protocol as RFID module 94.

Still referring to FIG. 3, battery 14A includes battery management system (BMS) 110 that provides a control system for battery 14A. BMS 110 controls aspects of battery's 14A performance, which may include protection from over-voltage and under-voltage conditions, cell balancing, thermal management, monitoring and communications. BMS 110 controls use-characteristics of battery 14A, which is connected to tool 12A by various conductive rails, wires, lines or the like for power and communication or signal transmission through discrete conductive paths, shown as power conductors 112 and communication conductors 114.

Still referring to FIG. 3, within tool control module 70, tool controller 72 controls switching the signal relay 74 to connect or disconnect communication conductors 114 between battery 14A and tool 12A. Signal relay 74 defines a normally open condition. Signal relay 74 closes and connects the communication conductors 114 from battery 14A to tool 12A only when the appropriate conditions exist from a PPE or safety equipment circuit that corresponds to detected presence of appropriate PPE 16. If at any time the operating safety equipment conditions are lost, corresponding to undetected required PPE 16, tool controller 72 may command deenergizing or locking out tool 12A and may implement a buffer time. The buffer may be an adjustable buffer time, such as a 10 second buffer time or other time selected by the programmer, before the tool 12A may be unlocked again. The relay connect/disconnect circuit, including communication conductors 114, is configured to cooperate with a specific brand(s) of tool 12A. In this way, the interrupter module 30 (FIG. 2) defines an interruptible path through communication conductors 114 that selectively prevents signal transmission or communication between battery 14A and tool 12A. When communication is prevented between battery 14A and tool 12A, BMS 110 prevents power transmission through power conductors 112 from battery 14A to tool 12A, locking out tool 12A or placing it in a locked non-use state.

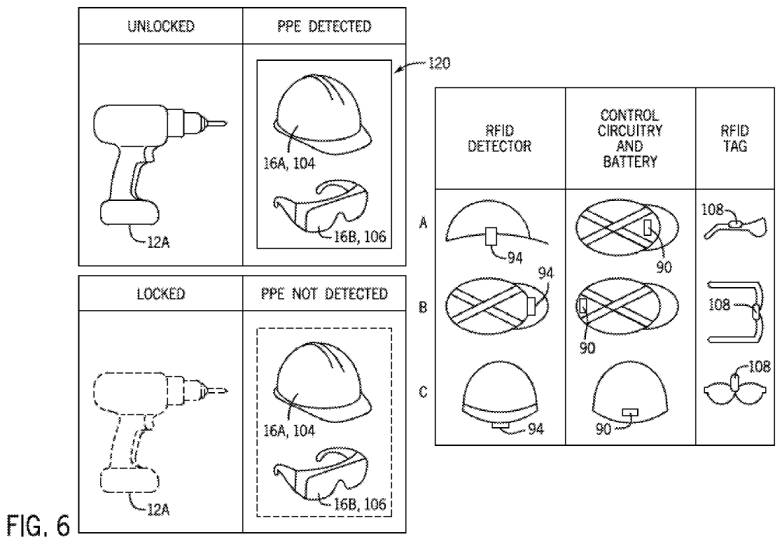

Referring now to FIG. 6, toward the top, a PPE detected condition is represented that unlocks tool 12A. A detected set of PPE 120 is shown with eye protection 16B close enough to hardhat 16A to correspond to both being worn by a user. Toward the right, various mounting positions of components are shown that allow detection of eye protection 16B by hardhat 16A. Still referring to FIG. 6 and with background reference to FIG. 3, as represented at Position A, the RFID sensor or detector such as RFID module 94 is shown at a side of hardhat 16A near the user's ear, control circuitry and battery such as PPE control module 90 is shown mounted on the inside surface toward the front of hardhat 16A, and RFID tag such as tag 108 is shown mounted to a side arm of eye protection 16B. As represented at Position B, the RFID detector is shown mounted flat on the bottom of the hardhat's 16A visor, control circuitry is shown mounted on the inside surface toward the back of hardhat 16A, and RFID tag is shown mounted on top of and between the eye segments of eye protection 16B. As represented at Position C, the RFID detector is shown mounted upright and extending downwardly from the bottom of the hardhat's 16A visor in front of the user's foreheat, control circuitry is shown mounted on an outside surface toward the back of hardhat 16A, and RFID tag is shown mounted on top of and extending upwardly from the eye segments of eye protection 16B in front of the user's forehead. Regardless, the RFID components are arranged on the various pieces of PPE 16 so that when the pieces of PPE are simultaneously worn, they are positioned close enough to each other so that the RFID sensor or detector can detect the RFID tag.

Still referring to FIG. 6, when the RFID tag(s) is detected associated with detected set of PPE 120, system 10 places tool 12A in its unlocked state (top) which can be freely used by the user. When the RFID tag(s) is not detected, system 10 places tool 12A in its locked state (bottom) which is deenergized and cannot be used.

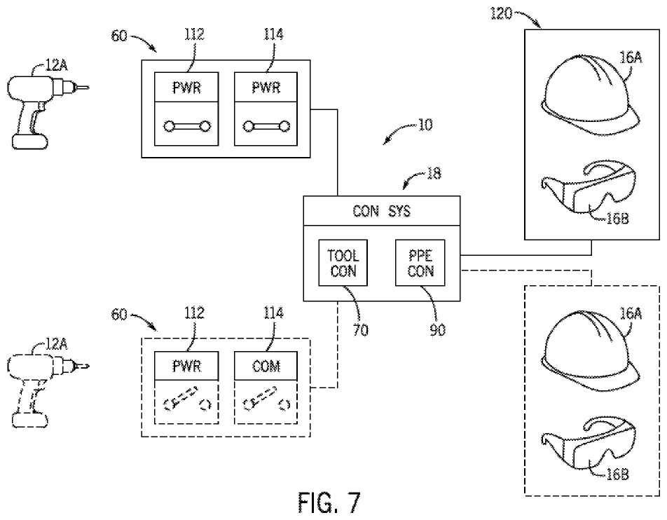

Referring now to FIG. 7, toward the top, when control system 18 detects the set of PPE 120, it commands closing of SR 74. This allows communication or signal transmission through communication conductors 114. When signal transmission through communication conductors 114 is permitted, BMS 110 (FIG. 3) may allow power transmission through power conductors 112 and tool 12A is unlocked. Toward the bottom of FIG. 7, when control system 18 does not detect the set of PPE 120, it commands opening of SR 74. This prevents communication or signal transmission through communication conductors 114. When signal transmission through communication conductors 114 is prevented, BMS 110 (FIG. 3) prevents power transmission through power conductors 112 and tool 12A is locked.

Referring generally to all FIGS. 1-7, system 10 generally operates as follows. Within the PPE-side control system 18B, initially, a user may use system 10 to define a whitelist of authorized RFID tag UIDs (unique identifiers) and store them in non-volatile memory either onboard or connected to a processor of control system 18. Control system 18 defines a current scan result variable holding the UID of a detected tag(s) 50 after being read. Control system 18 may define a Bluetooth connection status flag, initialized to false, define a transmission acknowledgment flag, initialized to false, and define a retry counter, initialized to zero. A maximum retry limit may be set, for example, to five attempts. System states may be defined such as, for example,: IDLE, TAG DETECTED, TAG VALIDATED, TAG REJECTED, BT CONNECTING, BT TRANSMITTING, AWAIT ACK, and FAULT.

During an initialization procedure, system 10 is powered on and appropriate definitions are initialized, along with peripherals including the RFID module 94 and BT module (not labeled). The whitelist of tags 50 are loaded from the memory. Self-tests on all peripherals are performed and if passed, initialization continues. If any do not pass, system 10 enters fault state. During a main loop procedure, the main loop process operates continuously and is structured as a state machine. On each iteration of the loop, a current system state is evaluated. During an idle state, RFID module 94 is continuously read to determine if a tag 50 is present within the RFID reader's field. Polling typically occurs at a defined interval to avoid over-power consumption or generation of excessive RF noise. If no tag 50 is detected during the poll, system 10 remains in the IDLE state and the loop is repeated. If the RFID module 94 signals that a tag 50 has entered the field, the full UID from the tag is read and the UID is stored in the current scan result variable. At this point, the system state transitions to TAG DETECTED.

During a tag detected state, the UID stored in the current scan result variable is compared against every entry in the Whitelist. The comparison typically requires a complete match, not a partial comparison, to prevent spoofing or intrusion tactics. If a match is found in the Whitelist, the system state transitions to TAG VALIDATED. If no match is found after exhausting the entire Whitelist, the system state transitions to TAG REJECTED. During a TAG VALIDATED state, a retry counter is reset to zero in preparation for the Bluetooth transmission attempt and the system state transitions to BT CONNECTING. During a TAG REJECTED state, a pause is conducted for a predetermined time to prevent rapid repeated rejection events if the invalid tag is currently being read, the system state transitions back to IDLE, and polling resumes.

During a BT connecting state, a Bluetooth connection is checked to determine if tool-side control system 18A and PPE-side control system 18B have already been communicatively connected. If a connection already exists, identified by the Bluetooth connection flag being set to true, the connection procedure is skipped and the system state transitions to BT TRANSMITTING. If no connection exists, system 10 commands the Bluetooth module to initiate a connection to the known MAC address or device name of tool controller 72 of tool-side control system 18A. A connection timeout timer begins and runs for a predetermined time, for example, three seconds. While the connection attempt is in progress, system 10 waits for either a connection success event or a timeout event from the Bluetooth module. If the connection succeeds before the timeout, the Bluetooth connection status flag is set to true and the system state transitions to BT TRANSMITTING. If the timeout expires before a connection is established, the retry counter is counted. If the retry counter has not exceeded the maximum limit, the process returns to the beginning of BT CONNECTING and its connection is attempted again. If the retry counter exceeds a maximum retry limit, the system state transitions to a FAULT state.

During a transmitting state, a command payload is constructed to be sent to tool controller 72. The payload typically follows a defined protocol frame structure, including a defined stop bit at conclusion of transmission/end of payload. System 10 instructs the Bluetooth module to transmit this payload to tool controller 72 and an acknowledgment timeout timer is ran for a predetermined time, for example, two seconds, and the system state transitions to AWAIT ACK. During an AWAIT ACK state, system 10 listens for an acknowledgment response from tool controller 72 over the Bluetooth link. If an acknowledgment is received, it is verified it to confirm it is a valid and uncorrupted response. If it passes and the acknowledgment confirms successful receipt, the transmission acknowledgment flag is set to true, the current scan result variable is cleared, and the system state transitions to TAG ACTIVE MONITORING. If the acknowledgment timeout expires before a valid acknowledgment is received, the retry counter is incremented. If the retry counter has not exceeded the maximum limit, the process returns to BT TRANSMITTING and the payload is resent. If the retry counter exceeds the maximum limit, the system state transitions to a FAULT state.

During a TAG ACTIVE MONITORING state, the SINK PIN on tool controller 72 is assumed to be active. RFID module 94 continuously polls at the same defined interval used in the IDLE state to determine whether the previously validated tag 50 remains in the field. If the tag 50 is still present and its UID still matches the Whitelist entry on re-read, system 10 remains in this state and polling continues. If the tag 50 leaves the field or a re-read fails to match the Whitelist, a deactivate command payload is constructed and transmitted to tool controller 72 over the existing Bluetooth connection. The deactivate payload typically follows the same protocol frame structure as the activate payload but carries a distinct command identifier byte so tool controller 72 can differentiate the two. The retry counter is reset and system 10 waits for acknowledgment from tool controller 72 using the same AWAIT ACK logic. Once acknowledgment is received, the system state transitions to IDLE and normal polling resumes.

During a fault state, all normal operations are halted. A soft reset of the faulted peripheral is attempted and an initialization routine after a predetermined delay is restarted. If the fault persists across a predefined number of reset attempts, system 10 halts entirely and requires a manual power cycle to recover. This prevents system 10 from entering an infinite fault-reset loop that could cover a deeper problem.

Within the tool-side control system 18A, tool controller 72 is a passive receiver. It waits for a valid Bluetooth command from PPE controller 92 of PPE-side control system 18B, validates it, pulls a single GPIO (General Purpose Input Output) pin low by driving the relay that controls communication conductors 114, and acknowledges back. System 10 defines a received frame buffer to hold incoming Bluetooth data as it arrives. A valid flag is defined and initialized to false. A GPIO output pin is defined, referred to as SINK PIN, which is configured as a digital output and initialized to a high state, meaning not connected to ground. System states may be defined such as, for example,: IDLE, RECEIVING, VALIDATING, PIN ACTIVE, and FAULT.

During an initialization procedure, when tool controller 72 powers on, the Bluetooth module is initialized. If it does not respond, system 10 enters the FAULT state and the process is halted. The SINK PIN is configured as a digital output driven high. The Bluetooth module is set to remain discoverable so that PPE controller 92 can locate and connect to it, the system state enters an IDLE state, and the main program loop begins. During an idle state, system 10 ensures that the SINK PIN is held high. The Bluetooth module monitors for any incoming data activity. If no data is arriving, system 10 remains in IDLE and repeats the loop. If the Bluetooth module signals that data is being received, it is captured into the frame buffer and the system state transitions to RECEIVING. During a receiving state, incoming information from the Bluetooth module is read into the frame buffer until a stop byte is detected, indicating the end of the frame as defined by PPE controller 92. Once the stop byte is received, the system state transitions to VALIDATING. During a validating state, complete checks on data received are performed. If all checks pass, the frame valid flag is set to true and the system state transitions to PIN ACTIVE. If any check fails, the frame buffer contents are deleted, the frame valid flag is set to false, and the system state transitions back to IDLE.

During a PIN active state, the SINK PIN is driven to low, connecting it to ground. A positive acknowledgment frame is immediately constructed and transmitted back to PPE controller 92 over the Bluetooth link so that PPE controller 92 can resolve its AWAIT ACK state. When a deactivate command is received from PPE controller 92, it is verified using the same validation checks used in the VALIDATING state. If the frame is valid, the SINK PIN is driven high, transmit a positive acknowledgement back to PPE controller 92, the frame buffer is cleared, the frame valid flag is reset, and the system state transitions back to IDLE. During a fault state, system 10 applies the same fault logic as previously described, including, for example, operating halting, soft reset attempts, initialization routine(s), and manual power cycle requirement(s).

The system may be implemented with, for example, portable tools, which are typically battery-operated tools that can be used on the go, including drills, reciprocating saws, sanders, etc. Other examples include stationary tools, which are typically tools that are stationary in manufacturing or construction, including table saws 12B (FIG. 1), lathes, band saws, etc. Yet other examples include vehicles, which are typically worksite vehicles that require PPE, including lift trucks or forklifts, lifts, dollies, etc. Other examples are related to roof access, which typically include checkpoint gates for roof access or any climbing point, such as a safety check point(s) for wearing PPE before using a ladder or stairs. Yet other examples include tool check-out/check-in systems, which are typically implemented for manual tools, such as saws, screw drivers, pliers, etc., and a tool user's PPE status may be automatically checked with without a supervisor or other individual.

Other aspects and characteristics of a power tool safety system are disclosed in the drawings attached hereto, the disclosure of which is expressly incorporated herein.

Certain terminology is used herein for purposes of reference only, and thus is not intended to be limiting. For example, terms such as “upper,” “lower,” “above,” and “below,” refer to directions in the drawings to which reference is made. Terms such as “front,” “back,” “rear,” “bottom,” and “side,” describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first,” “second,” and other such numerical terms referring to structures do not imply a sequence or order unless clearly indicated by the context.

When introducing elements or features of the present disclosure and the exemplary embodiments, the articles “a,” “an,” “the,” and “said,” are intended to mean that there are one or more of such elements or features. The terms “comprising”, “including,” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

References to “a controller,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

Many changes and modifications could be made to the invention without departing from the spirit thereof. The scope of these changes will become apparent from the appended claims.

What is claimed is:

1. A power tool safety system comprising:
a piece of PPE (personal protection equipment);
a power tool;
a power supply configured to deliver power to the power tool;
an interrupter system in communication with the power tool and the power supply; the interrupter system configured to detect absence or presence of the piece of PPE and control power distribution from the power supply to the power tool based on the detection.

2. The power tool safety system of claim 1, wherein the interrupter system comprises:
an interrupter module arranged between the power tool and the power supply; the interrupter module including
a PPE detector configured to detect the absence or presence of the piece of PPE;
a power disconnect arrangement in operable communication with the PPE detector, the power disconnect arrangement configured to selectively prevent or permit delivery of power from the power supply to the power tool based on a detected absence or presence status of PPE from the PPE detector.

3. The power tool safety system of claim 2, wherein:
the PPE detector is configured to detect the absence or presence of at least:
a first piece of PPE; and
a second piece of PPE
the power disconnect arrangement is configured to selectively prevent or permit delivery of power from the power supply to the power tool based on a detected absence or presence status of both the first and second pieces of PPE.

4. The power tool safety system of claim 1, wherein:
the interrupter system:
comprises a location detector configured to detect a location of the tool, and
determines number and type of PPE required for tool operation based on the location of the tool; and
comprises an interrupter module arranged between the power tool and the power supply; the interrupter module including:
a PPE detector configured to detect the absence or presence of the piece of PPE;
a power disconnect arrangement in operable communication with the PPE detector, the power disconnect arrangement configured to selectively prevent or permit delivery of power from the power supply to the power tool based on a detected absence or presence status of PPE from the PPE detector.

5. The power tool safety system of claim 2, wherein the interrupter system is arranged at least partially between the power tool and the power supply.

6. An interrupter system for selectively permitting or preventing operation of a power tool, the interrupter system comprising:
a tool detector configured to detect a location of a power tool receiving power from a power supply;
a PPE detector configured to detect the absence or presence of the piece of PPE;
a power disconnect arrangement in operable communication with the PPE detector, the power disconnect arrangement configured to selectively prevent or permit delivery of power from the power supply to the power tool based on a detected absence or presence status of PPE from the PPE detector.

7. A power tool safety system comprising:
a cordless power tool that includes:
a tool body; and
a battery that selectively delivers electrical power to the tool body for use of the cordless power tool;
a set of PPE (personal protection equipment) that includes:
a first piece of PPE configured to be worn by a user during use of the cordless power tool;
a second piece of PPE configured to be worn by a user during use of the cordless power tool;
a tool lockout system that includes:
a tool-side control system arranged at the cordless power tool and configured to selectively unlock or lock the cordless power tool by permitting or preventing power transmission from the battery to the tool body;
a PPE-side control system arranged at the set of PPE and configured to detect presence or absence of at least one of the first and second pieces of PPE and communicate a corresponding PPE status message to the tool-side control system; and
wherein:
when the PPE status message corresponds to a satisfied PPE requirement, the tool-side control system unlocks and permits use of the cordless power tool.

8. The power tool safety system of claim 7, wherein:
the PPE-side control system includes a PPE detector configured to wirelessly detect a PPE tag;
the first piece of PPE defines a primary piece of PPE;
the PPE detector is arranged at the primary piece of PPE;
the second piece of PPE defines a secondary piece of PPE;
the PPE tag is arranged at the secondary piece of PPE; and
when the primary and secondary pieces of PPE are simultaneously worn by the user, the PPE tag of the secondary piece of PPE is positioned within a readable range of the PPE detector of the primary piece of PPE.

9. The power tool safety system of claim 8, wherein:
the PPE detector is a RFID (radio-frequency identification) reader mounted to the primary piece of PPE;
the PPE tag is an RFID tag mounted to the secondary piece of PPE.

10. The power tool safety system of claim 9, wherein:
the piece of primary PPE is a hardhat and the RFID reader is mounted to extend from a surface of the hardhat;
the piece of secondary PPE is eye protection and the RFID tag is mounted to the eye protection to align with the RFID reader when both the hardhat and eye protection are worm by a user.

11. The power tool safety system of claim 7, wherein:
the cordless power tool includes:
a power conductor that extends between the tool body and the battery for transmitting electrical power from the battery to the tool body during use of the cordless power tool;
a communication conductor that extends between the tool body and the battery for transmitting signals for control of battery usage; and
the tool lockout system is configured to selectively permit or prevent signal transmission through the communication conductor to correspondingly unlock the cordless power tool for use or lock the cordless power for non-use.

12. The power tool safety system of claim 11, wherein the tool-side control system is arranged in the tool body.

13. The power tool safety system of claim 11, wherein the tool-side control system is arranged in an adapter housing that is arranged between the tool body and the battery.

14. The power tool safety system of claim 13, wherein the adapter housing includes:
a tool connector at an upper end that defines a locked connection with the tool body; and
a battery connector at a lower end that defines an unlocked connection with the battery to facilitate toolless connection of the battery to the adapter housing.

15. A method of controlling use of a power tool based on presence or absence of PPE (personal protection equipment), the method comprising:
locking a tool to prevent tool usage in a default state;
detecting a piece of PPE with a PPE-side control system;
communicating a PPE status message from the PPE-side control system to a tool-side control system;
unlocking the tool to permit tool usage with the tool-side control system to correspond to the detected presence of the piece of PPE.

16. The method of claim 15, further comprising:
locking the tool with the tool-side control system by preventing signal transmission through a communication conductor that extends between the tool and the battery; and
unlocking the tool with the tool-side control system by permitting signal transmission through the communication conductor.
